(19) United States
(12) Patent Application Publication
(10) Pub. No.: US 2018/0373705 A1
(43) Pub. Date: Dec. 27, 2018

(54) USER DEVICE AND COMPUTER PROGRAM FOR TRANSLATING RECOGNIZED SPEECH

(71) Applicant: Denobiz Corporation, Gangneung-si (KR)

(72) Inventor: YONG SOON KWON, Gangneung-si (KR)

(21) Appl. No.: 15/646,554

(22) Filed: Jul. 11, 2017

(30) Foreign Application Priority Data
Jun. 23, 2017 (KR) 10-2017-0079764

(51) Int. Cl. G06F 17/28; G10L 15/22; G10L 15/16

(52) U.S. Cl. CPC G06F 17/2836; G10L 15/16; G10L 15/22

(57) ABSTRACT

There is provided a computer-readable storage medium having stored thereon a computer program comprising instructions, wherein the instructions, when executed by one or more processors of a computer device, causes the one or more processors to perform a method for translating a recognized speech, wherein the method comprises operations of: receiving, by the computer device, a first user voice in a first language; delivering, by the computer device, the first user voice in the first language to a deep-learning neural network, thereby to derive a translated sentence in a second language, wherein the translated sentence corresponds to the first user voice in the first language; and outputting, by the computer device, at least one of audio information and text information corresponding to the translated sentence.

### BACKGROUND

### Field of the Present Disclosure

The present disclosure relates to language translation. More particularly, the present disclosure relates to translation of recognized speech.

### Discussion of Related Art

Recently, international exchanges between the international communities are expanding globally. International exchanges of information and resources are being actively carried out. Especially, as the number of foreign tourists and resident foreigners increase, the frequency of communication with foreigners is also increasing.

On the other hand, there are various kinds of foreign languages, and there is limitation as to how people can learn and understand foreign languages.

Thus, there is a need in the art for accurate and easy translation methods.

Korean Patent No. 10-2010-0132956 discloses a user terminal capable of real-time automatic translation, and a real-time automatic translation method.

In this document, the user terminal extracts characters to be translated from an image of a foreign document photographed by the user terminal, recognizes the meaning of the characters, and translates the meaning into the user's language, and displays the translated language on a display of the user terminal. However, there is a limitation in that this approach does not provide a translation system that facilitates conversation with foreigners.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

The present disclosure is made based on the above-mentioned problem. The present disclosure is to provide an easy and accurate translation of the recognized speech.

In one aspect, there is provided a computer-readable storage medium having stored thereon a computer program comprising instructions, wherein the instructions, when executed by one or more processors of a computer device, causes the one or more processors to perform a method for translating a recognized speech, wherein the method comprises operations of: receiving, by the computer device, a first user voice in a first language; delivering, by the computer device, the first user voice in the first language to a deep-learning neural network, thereby to derive a translated sentence in a second language, wherein the translated sentence corresponds to the first user voice in the first language; and outputting, by the computer device, at least one of audio information and text information corresponding to the translated sentence.

In one implementation of the computer-readable storage medium, the operation of delivering, by the computer device, the first user voice in the first language to the deep-learning neural network, thereby to derive the translated sentence in the second language comprises: generating, by the deep-learning neural network, at least one translation model based on contextual conditions; selecting, by the deep-learning neural network, among the at least one translation model, a specific translation model corresponding to a contextual condition where the first user voice in the first language is received; and deriving the translated sentence based at least on the specific translation model.

In one implementation of the computer-readable storage medium, the method further comprises receiving, by the computer device, information related to a location where the first user voice in the first language is received, wherein the operation of delivering, by the computer device, the first user voice in the first language to the deep-learning neural network, thereby to derive the translated sentence in the second language comprises: deriving the translated sentence in the second language based at least in part on the information related to the location.

In one implementation of the computer-readable storage medium, the information related to the location where the first user voice in the first language is received comprises at least one of: location information relating to the location, climate information related to the location, money currency exchange information related to the location, and classification information of a business related to the location.

In one implementation of the computer-readable storage medium, the operation of delivering, by the computer device, the first user voice in the first language to the deep-learning neural network, thereby to derive the translated sentence in the second language comprises: transforming the first user voice in the first language into a text in the first language; and translating the text in the first language into a text in the second language.

In one implementation of the computer-readable storage medium, the method further comprises: identifying, by the computer device, the first language from the first user voice; receiving a second user voice in a third language; and delivering, by the computer device, the second user voice in the third language to the deep-learning neural network, thereby to derive a further translated sentence in the first language; and outputting, by the computer device, at least one of audio information and text information corresponding to the further translated sentence.

In one implementation of the computer-readable storage medium, the deep-learning neural network is configured to: collect information from at least one of a translation API, an internet web site, an online dictionary and a literature database; analyze the information; and generate from the analyzed information at least one or more translation models based on contextual conditions.

In one implementation of the computer-readable storage medium, upon being deeply learned using at least one algorithm of DNN (Deep Neural Network), CNN (Convolutional Neural Network), RNN (Recurrent Neural Network), RBM (Restricted Boltzmann machine), DBN (Deep Belief Network) and Depp Q-Network, the deep-learning neural network is configured to derive the translated sentence corresponding to the first user voice in the first language.

In another aspect, there is provided a method for translating a recognized speech, wherein the method comprises operations of: receiving, by a computer device, a first user voice in a first language; delivering, by the computer device, the first user voice in the first language to a deep-learning neural network, thereby to derive a translated sentence in a second language, wherein the translated sentence corresponds to the first user voice in the first language; and outputting, by the computer device, at least one of audio information and text information corresponding to the translated sentence.

In one implementation of the method, the operation of delivering, by the computer device, the first user voice in the first language to the deep-learning neural network, thereby to derive the translated sentence in the second language comprises: generating, by the deep-learning neural network, at least one translation model based on contextual conditions; selecting, by the deep-learning neural network, among the at least one translation model, a specific translation model corresponding to a contextual condition where the first user voice in the first language is received; and deriving the translated sentence based at least on the specific translation model.

In one implementation of the method, the method further comprises receiving, by the computer device, information related to a location where the first user voice in the first language is received, wherein the operation of delivering, by the computer device, the first user voice in the first language to the deep-learning neural network, thereby to derive the translated sentence in the second language comprises: deriving the translated sentence in the second language based at least in part on the information related to the location.

In one implementation of the method, the information related to the location where the first user voice in the first language is received comprises at least one of: location information relating to the location, climate information related to the location, money currency exchange information related to the location, and classification information of a business related to the location.

In one implementation of the method, the method further comprises: identifying, by the computer device, the first language from the first user voice; receiving a second user voice in a third language; and delivering, by the computer device, the second user voice in the third language to the deep-learning neural network, thereby to derive a further translated sentence in the first language; and outputting, by the computer device, at least one of audio information and text information corresponding to the further translated sentence.

In one implementation of the method, the method further comprises: the deep-learning neural network collecting information from at least one of a translation API, an internet web site, an online dictionary and a literature database; the deep-learning neural network analyzing the information; and the deep-learning neural network generating from the analyzed information at least one or more translation models based on contextual conditions.

In further aspect, there is provided a user device for translating a recognized speech, wherein the device comprises: a receiving module configured to receive a first user voice in a first language; a control module configured to deliver the first user voice in the first language to a deep-learning neural network, thereby to derive a translated sentence in a second language, wherein the translated sentence corresponds to the first user voice in the first language; and an outputting module configured to output at least one of audio information and text information corresponding to the translated sentence.

In one implementation of the device, the deep-learning neural network is configured to: generate at least one translation model based on contextual conditions; select, among the at least one translation model, a specific translation model corresponding to a contextual condition where the first user voice in the first language is received; and derive the translated sentence based at least on the specific translation model.

In one implementation of the device, the receiving module is further configured to receive information related to a location where the first user voice in the first language is received, wherein the deep-learning neural network is configured to derive the translated sentence in the second language based at least in part on the information related to the location.

In one implementation of the device, the information related to the location where the first user voice in the first language is received comprises at least one of: location information relating to the location, climate information related to the location, money currency exchange information related to the location, and classification information of a business related to the location.

In one implementation of the device, the control module is further configured to identify the first language from the first user voice, wherein the receiving module is further configured to receive a second user voice in a third language, wherein the control module is further configured to deliver the second user voice in the third language to the deep-learning neural network, thereby to derive a further translated sentence in the first language, wherein the outputting module is further configured to output at least one of audio information and text information corresponding to the further translated sentence.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a block diagram of a user device for translating a recognized speech according to embodiments of the present disclosure.

FIG. 2 is a flow chart of a method for translating a recognized speech according to embodiments of the present disclosure.

FIG. 3 is a flow chart of a method for translating a recognized speech in accordance with embodiments of the present disclosure.

### DETAILED DESCRIPTIONS

Examples of various embodiments are illustrated and described further below. It will be understood that the description herein is not intended to limit the claims to the specific embodiments described. On the contrary, it is intended to cover plate alternatives, modifications, and equivalents as may be included within the spirit and scope of the present disclosure as defined by the appended claims.

Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, terms “unit” and “module” refer to means that processes at least one function or operation, and may be implemented in hardware, software, or a combination thereof.

In embodiments of the present invention, each component, function block or means may include one or more sub-components, function sub-blocks, or sub-means. Electrical and electronic functions performed by each component may be implemented with well-known electronic circuits, integrated circuits, or ASICs Application Specific Integrated Circuits, or the like. The electrical and electronic functions may be implemented separately or in a combination thereof.

Further, each block of the accompanying block diagrams, and each step of the accompanying flowchart may be performed by computer program instructions. These computer program instructions may be embedded within a processor of a general purpose computer, a special purpose computer, or other programmable data processing devices. Thus, the instructions when executed by the processor of the computer or other programmable data processing device will generate means for performing a function described in each block of the block diagram or each step of the flow chart.

These computer program instructions may be stored in a computer usable or computer readable memory coupled to the computer or other programmable data processing device to implement the functions in a particular manner. As such, the instructions stored in such a computer-usable or computer-readable memory enable the production of articles with instruction means that perform a function described in each block of the block diagram or each step of the flow chart.

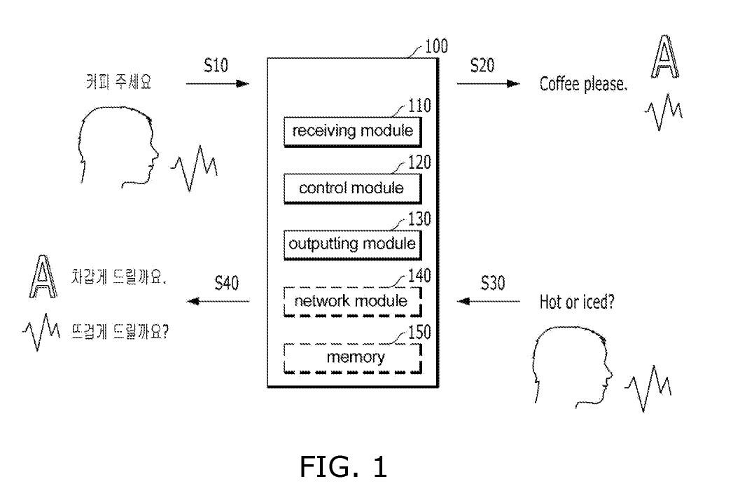

FIG. 1 is a block diagram of a user device for translating a recognized speech according to embodiments of the present disclosure.

In embodiments of the present disclosure, the user device 100 for translating the recognized speech includes a receiving module 110, a control module 120, and an output module 130. The above-described configuration of FIG. 1 is illustrative, and the scope of the present disclosure is not limited thereto. For example, the user device 100 for translating the recognized speech may further include at least one of a network module 140 and a memory 150.

As used herein, the terms “the user device for translating the recognized speech” and “the user device” are often used interchangeably.

Hereinafter, the components of the user device 100 according to embodiments of the present disclosure will be described in details.

In some embodiments of the present disclosure, the receiving module 110 may receive a voice of a speaker. For example, the receiving module 110 may receive a first user voice in a first language. The receiving module 110 may include a microphone module for receiving a user's voice.

In some embodiments of the present disclosure, the receiving module 110 delivers the received voice (voice signal, voice information) to the control module 120.

In some embodiments of the present disclosure, the receiving module 110 may receive information related to a location where the first user voice in the first language is received.

In some embodiments of the present disclosure, the information related to the location where the first user voice is received may be determined based on location information collected by a location identification module of the user device 100.

Alternatively, the information related to the location where the first user voice is received may be determined as location information (e.g., a cafe, an airport, etc.) previously input from the user device 100.

In another example, the information related to the location where the first user voice is received may be determined based on the pre-input business code information associated with the user device 100. In more detail, the user device 100 may be a POS (Point Of Sale) terminal provided in a shop. The POS terminal automatically collects and records, at a point of sales, data used in individual sales management, inventory management, customer management, sales amount management, and administration management, etc. at department stores, supermarkets, discount stores, convenience stores, and retail stores. Etc. In general, the POS terminal may have a register function, a filing function for temporarily recording data, and an online function for sending the data of the point-of-sale to a parent device (e.g., a host computer in a headquarter). Generally, the POS terminal is implemented to receive business type information in advance for efficient sales management. Accordingly, when the user device 100 is employed as the POS terminal, the information related to the location where the first user voice is received may be determined using the business type information.

In some embodiments of the present disclosure, when the user device 100 for translating the recognized speech according to embodiments of the present disclosure is employed as an existing device (e.g., a POS terminal) which has used in the business shop, a burden of replacing the user device and/or resistance to a new device may be removed.

The information related to the location in which the first user voice in the first language is received, as described above, includes location information associated with the location, climate information associated with the location, currency exchange information associated with the location, and business classification information associated with the location. The present disclosure is not limited thereto.

In some embodiments of the present disclosure, the control module 120 delivers the first user voice in the first language to a deep-learning neural network. This deep-learning neural network may derive a translated sentence in a second language.

In this connection, the second language may be determined based on the information on the location of the user device 100 according to the present disclosure embodiments, or may be pre-set from the user using the user device 100.

In some embodiments of the present disclosure, the deep-learning neural network may analyze information gathered from at least one of a translation API, an internet web site, dictionary and literature data, etc. However, the present disclosure is not limited thereto.

In some embodiments of the present disclosure, the deep-learning neural network may generate at least one translation model based on contextual conditions from the analyzed information.

In some embodiments of the present disclosure, among the at least one translation model, a specific translation model corresponding to a contextual condition where the first user voice in the first language is received may be selected. Then, the translated sentence may be derived based at least on the specific translation model.

In this connection, the contextual condition may include information related to the location where the first user voice is received. In another example, the contextual condition may include mood information determined based on a tone and speed of the first user voice. For example, when the first user voice is recognized to have a high tone and speed, the contextual condition may be determined to be an “angry” mood. As another example, the contextual condition may include gender information determined based on the first user voice. Those are only examples of the present disclosure, and, thus, the present disclosure is not limited.

In some embodiments, the deep-learning neural network as described above may use at least one algorithm of DNN (Deep Neural Network), CNN (Convolutional Neural Network), RNN (Recurrent Neural Network), RBM (Restricted Boltzmann machine), DBN (Deep Belief Network) and Depp Q-Network. However, the present disclosure is not limited thereto.

In other words, in some embodiments of the present disclosure, upon being deeply learned using at least one algorithm of DNN (Deep Neural Network), CNN (Convolutional Neural Network), RNN (Recurrent Neural Network), RBM (Restricted Boltzmann machine), DBN (Deep Belief Network) and Depp Q-Network, the deep-learning neural network may derive the translated sentence for the first user voice in the first language.

In some embodiments of the present disclosure, when the learned data via the algorithm used to derive the translated sentence for the first user voice in the first language is not available, necessary information is collected via a connection to a translation API, the Internet, a big data server, or a database. By analyzing the collected information, the optimum data may be calculated and the calculated data may be recorded and referred to in a next translation.

In some embodiments of the present disclosure, when the learned data via the algorithm used to derive the translated sentence for the first user voice in the first language is available, the optimum data may be obtained by searching the learned data, analyzing the collected information, and prioritizing them. In order to determine the priority, the contextual condition as described above may be considered. For example, the priorities may be determined by assigning different weights to the learned data based on the contextual condition. In order to determine the priorities, the user device may also refer to the user's feedback about previous translation results.

In some embodiments of the present disclosure, when the learned data via the algorithm used to derive the translated sentence for the first user voice in the first language is not available, necessary information is collected via a connection to a translation API, the Internet, a big data server, or a database. In this way, the user device 100 in accordance with some embodiments of the present disclosure may be learned, thereby improving the quality of translation.

In some embodiments, the user device may perform translation based at least in part on information related to the location where the first user voice in the first language is received.

For example, when the user voice in an English language is “too hot”, it may be translated into a Korean language “ [symbol] ” (in terms of weather) or “ [symbol] ” (in terms of water temperature) depending on the location where the first user voice in the first language is received.

As described above, the information related to the location where the first user voice in the first language is received includes the location information related to the location, the climate information related to the location, the currency exchange information related to the location, and the business classification information associated with the location. The present disclosure is not limited thereto.

In one example, when the first user voice in English is “is it 4$?”, it may be translated to a Korean language “5000 [symbol] ” based on the currency exchange information associated with the location.

In some embodiments of the present disclosure, the first user voice in a first language may be recognized as a text in the first language. The text in the first language may be translated into a text in the second language. Thereby, translation of the recognized speech may be performed.

In some embodiments of the present disclosure, the control module 120 may determine the first language based on the first user voice. In this connection, various known techniques for determining a language from a recognized speech may be applied to the present disclosure.

In some embodiments of the present disclosure, the control module 120 controls the components of the user device 100 and governs all operations of the user device 100 according to embodiments of the present disclosure.

In some embodiments of the present disclosure, the output module 130 may output at least one of audio information and text information corresponding to the translated sentence.

In some embodiments of the present disclosure, the output module 130 may be configured to output voice information. For example, the output module 130 may include a loudspeaker module.

In some embodiments of the present disclosure, the output module 130 may be configured to output text information and/or image information. For example, the output module 130 may include a display module.

In some embodiments of the present disclosure, the output module 130 may output the translated sentence for the visually impaired and/or the hearing impaired in a form that the visually impaired and/or the hearing impaired can understand.

In some embodiments of the present disclosure, the user device 100 may be operated in connection with a web storage over the Internet by a network module 140. The web storage may perform a storage function. The network module 140 may be implemented as at least one of a wireless network module, a wired network module, and a local area network module.

In some embodiments of the present disclosure, the network module 140 may receive information from at least one of a translation API, an Internet web site, dictionaries, and literature database to allow continuous learning of the deep-learning neural network for translating recognized speech.

In some embodiments of the present disclosure, the memory 150 may store therein a program for processing and controlling operations by the control module 120. In addition, the memory 150 may perform a temporary storage of input/output data. Such memory 150 may be embodied as any of known storage media. As another example, the memory 150 may operate in association with the web storage performing the storage function of over the Internet.

The various embodiments described herein may be implemented in a recording medium readable by a computer or other machine, using, for example, software, hardware, or a combination thereof.

According to a hardware implementation, the embodiments described herein may be implemented using at least one of ASICs (application specific integrated circuits), DSPs (digital signal processors), DSPDs (digital signal processing devices), PLDs (programmable logic devices), FPGAs (field programmable gate arrays), processors, controllers, microcontrollers, microprocessors, and electrical units for performing other functions. In some cases, the embodiments described herein may be implemented using the control module 120 itself.

According to a software implementation, embodiments such as the procedures and functions described herein may be implemented with separate software modules. Each of the software modules may perform one or more of the functions and operations described herein. The software module may be implemented with a software application written in a suitable programming language. The software module may be stored in the memory 1₅0 and executed by the control module 120.

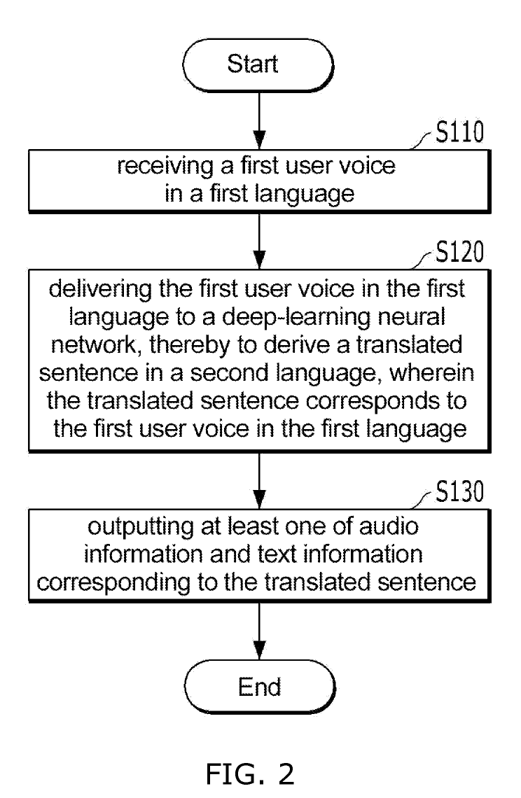

FIG. 2 is a flow chart of a method for translating a recognized speech according to embodiments of the present disclosure.

Operation S110 to operation S130 shown in FIG. 2 may be performed by the user device 100.

Each operation described in FIG. 2 is only an exemplary operation of the method for translating a recognized speech. The order of each operation may be changed and/or operations may be integrated. Further, additional operations other than the operations shown may be implemented.

In the following description, the overlapping portions as described with reference to FIG. 1 will not be described.

In some embodiments of the present disclosure, a first user voice in a first language is received S110.

In some embodiments of the present disclosure, the first user voice in the first language may be delivered to the deep-learning neural network, thereby to generate a translated sentence in a second language S120.

In some embodiments of the present disclosure, as at least one of audio information and text information corresponding to the translated sentence derived by operation S120 may be output S130.

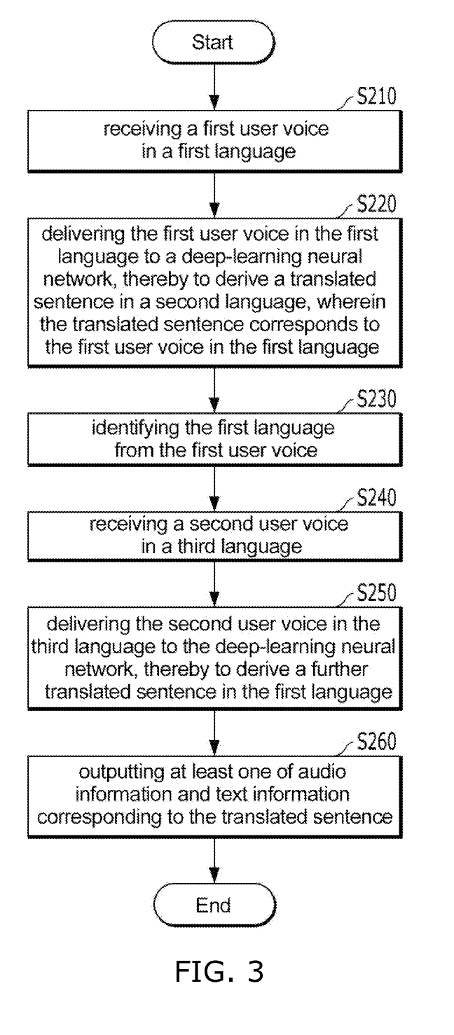

FIG. 3 is a flow chart of a method for translating a recognized speech according to embodiments of the present disclosure.

Operation S210 to operation S260 shown in FIG. 3 may be performed by the user device 100.

Each operation described in FIG. 3 is only an exemplary operation of the method for translating a recognized speech. The order of each operation may be changed and/or operations may be integrated. Further, additional operations other than the operations shown may be implemented.

In the following description, the overlapping portions as described with reference to FIG. 1 and FIG. 2 will not be described.

In some embodiments of the present disclosure, a first user voice in a first language is received S210.

In some embodiments of the present disclosure, the first user voice in the first language may be delivered to the deep-learning neural network, resulting in a translated sentence in a second language S220.

In some embodiments of the present disclosure, the first language may be identified from the first user voice S230.

In some embodiments of the present disclosure, a second user voice in a third language may be received S240.

In this connection, the third language may be the same as the second language, for example.

In some embodiments of the present disclosure, the second user voice in the third language is delivered to the deep-learning neural network, resulting in a translated sentence in the first language S250.

In some embodiments of the present disclosure, the first user may be a foreign customer visiting a restaurant, for example, where the user device 100 according to embodiments of the present disclosure is located. The second user may be an employee working at the restaurant, for example, where the user device 100 according to embodiments of the present disclosure is located.

In some embodiments of the present disclosure, at least one of audio information and text information corresponding to the translated sentence derived by operation S220 and operation S250 may be output S260.

According to embodiments of the present disclosure, the first user voice in the first language may be translated into the translated sentence in the second language which in turn may be provided to the second user. The second user voice in the third language may be translated into the translated sentence in the first language identified from the first user voice in the first language. Then, the translated sentence in the first language may be provided to the first user. In this connection, the second language and the third language may be the same. Alternatively, or alternatively, the second language and the third language may be different. In accordance with the embodiments of the present disclosure including the operations described above, real-time conversations between users using different languages may be enabled.

In one example, the first user voice in the first language is “How much is this?”. Then, the translated sentence in the second language provided to the second user is “ [symbol] ?”. In response to this, the second user voice in the third language (which is the same language in this example) is “3000 [symbol] ”. Then, the translated sentence in the first language identified from the first user voice in the first language provided to the first user is “It's $8”. In this example, the first language is English and the second language and the third language is Korean. However, the present disclosure is not limited thereto.

In this regard, referring again to FIG. 1, the first user voice in the first language may be received S10. The first user voice in the first language may be translated into the translated sentence based on the location on which the first user voice in the first language was received.

In this connection, the translated sentence in the second language may be derived by transmitting the first user voice in the first language to the deep-learning neural network, where the deep-learning neural networks translates the first user voice in the first language into the translated sentence in the second language, as described above with reference to FIG. 1.

At least one of audio information and text information corresponding to the translated sentence may be output S20.

In some embodiments of the present disclosure, the second user voice in the third language may be received S30. In this connection, the third language may be the same as the second language, for example.

In some embodiments of the present disclosure, the second user voice in the third language is delivered to the deep-learning neural network, thereby resulting in the translated sentence in the first language. Then, at least one of audio information and text information corresponding to the translated sentence in the first language may be output to the second user S40.

The computer program stored on the computer readable storage medium and the user device for translating the recognized speech according to the embodiments of the present disclosure as described above with reference to FIGS. 1 to 3 may provide for an artificial intelligence network-based translation system that learns daily conversation-oriented contents using a Big Data on its own, and translates contextual-conversations based on the learned contents. Accordingly, an accurate translation can be presented.

The computer program stored in the computer-readable storage medium for translating the recognized speech according to embodiments of the present disclosure may be embedded in a user device such as a POS terminal, a smart menu plate, a kiosk, an IP telephone, or the like in a shop. Accordingly, a bidirectional interpretation service can be easily presented.

The description of the disclosed embodiments is provided to enable any person skilled in the art to make or use the invention. Various modifications to these embodiments will be readily apparent to those skilled in the art upon reading the present disclosure. The generic principles defined herein may be applied to other embodiments without departing from the scope of the present disclosure. Thus, the present disclosure is not to be construed as limited to the embodiments set forth herein but is to be accorded the widest scope consistent with the principles and novel features presented herein.

What is claimed is:

1. A computer-readable storage medium having stored thereon a computer program comprising instructions, wherein the instructions, when executed by one or more processors of a computer device, causes the one or more processors to perform a method for translating a recognized speech, wherein the method comprises operations of:
receiving, by the computer device, a first user voice in a first language;
delivering, by the computer device, the first user voice in the first language to a deep-learning neural network, thereby to derive a translated sentence in a second language, wherein the translated sentence corresponds to the first user voice in the first language; and
outputting, by the computer device, at least one of audio information and text information corresponding to the translated sentence.

2. The computer-readable storage medium of claim 1, wherein the operation of delivering, by the computer device, the first user voice in the first language to the deep-learning neural network, thereby to derive the translated sentence in the second language comprises:
generating, by the deep-learning neural network, at least one translation model based on contextual conditions;
selecting, by the deep-learning neural network, among the at least one translation model, a specific translation model corresponding to a contextual condition where the first user voice in the first language is received; and
deriving the translated sentence based at least on the specific translation model.

3. The computer-readable storage medium of claim 1, wherein the method further comprises receiving, by the computer device, information related to a location where the first user voice in the first language is received,
wherein the operation of delivering, by the computer device, the first user voice in the first language to the deep-learning neural network, thereby to derive the translated sentence in the second language comprises: deriving the translated sentence in the second language based at least in part on the information related to the location.

4. The computer-readable storage medium of claim 1, wherein the information related to the location where the first user voice in the first language is received comprises at least one of:
location information relating to the location,
climate information related to the location,
money currency exchange information related to the location, and
classification information of a business related to the location.

5. The computer-readable storage medium of claim 1, wherein the operation of delivering, by the computer device, the first user voice in the first language to the deep-learning neural network, thereby to derive the translated sentence in the second language comprises:
transforming the first user voice in the first language into a text in the first language; and
translating the text in the first language into a text in the second language.

6. The computer-readable storage medium of claim 1, wherein the method further comprises:
identifying, by the computer device, the first language from the first user voice;
receiving a second user voice in a third language; and
delivering, by the computer device, the second user voice in the third language to the deep-learning neural network, thereby to derive a further translated sentence in the first language; and
outputting, by the computer device, at least one of audio information and text information corresponding to the further translated sentence.

7. The computer-readable storage medium of claim 1, wherein the deep-learning neural network is configured to:
collect information from at least one of a translation API, an internet web site, a online dictionary and a literature database;
analyze the information; and
generate from the analyzed information at least one or more translation models based on contextual conditions.

8. The computer-readable storage medium of claim 1, wherein upon being deeply learned using at least one algorithm of DNN (Deep Neural Network), CNN (Convolutional Neural Network), RNN (Recurrent Neural Network), RBM (Restricted Boltzmann machine), DBN (Deep Belief Network) and Depp Q-Network, the deep-learning neural network is configured to derive the translated sentence corresponding to the first user voice in the first language.

9. A user device for translating a recognized speech, wherein the device comprises:
a receiving module configured to receive a first user voice in a first language;
a control module configured to deliver the first user voice in the first language to a deep-learning neural network, thereby to derive a translated sentence in a second language, wherein the translated sentence corresponds to the first user voice in the first language; and
an outputting module configured to output at least one of audio information and text information corresponding to the translated sentence.
